(19) United States
(12) Patent Application Publication
(10) Pub. No.: US 2014/0149795 A1
(43) Pub. Date: May 29, 2014

(54) INFORMATION PROCESSING APPARATUS AND METHOD RELATING TO HARDWARE DIAGNOSIS

(71) Applicant: FUJITSU LIMITED, Kawasaki-shi (JP)

(72) Inventors: Yuichi MUSHA, Kawasaki (JP); Akihiro YAMAZAKI, Kawasaki (JP)

(73) Assignee: FUJITSU LIMITED, Kawasaki-shi (JP)

(21) Appl. No.: 14/171,822

(22) Filed: Feb. 4, 2014

Related U.S. Application Data
(63) Continuation of application No. PCT/JP2011/069755, filed on Aug. 31, 2011.

(51) Int. Cl. G06F 11/07

(52) U.S. Cl. CPC G06F 11/0712
USPC 714/30

(57) ABSTRACT

A disclosed apparatus includes a memory and circuitry that is configured to execute an operating system, and realize one or plural logical domains that provide a predetermined function as a computer and a hypervisor that manages the logical domain. The operating system is configured to: detect hardware to be diagnosed; upon detecting the hardware to be diagnosed, secure a memory area in the memory, which is used for diagnosis by the operating system; instruct a kernel of the operating system to ignore an error that will occur in the secured memory area; and output a diagnosis request that instructs to ignore the error and includes designation of the hardware to be diagnosed to the hypervisor. The hypervisor is configured to execute: upon receipt of the diagnosis request, perform a setting to ignore the error that will occur; and perform the diagnosis for the hardware.

### CROSS-REFERENCE TO RELATED APPLICATIONS

This application is a continuing application, filed under 35 U.S.C. section 111(a), of International Application PCT/JP2011/069755, filed on Aug. 31, 2011.

### FIELD

This technique relates to a technique for managing hardware resources in a virtualized environment.

### BACKGROUND

When the power is supplied to the computer, the Power On Self Test (POST) is performed before activating the Operating System (OS), and the diagnosis of hardware such as the processor and memory is performed. The POST is the diagnosis that is executed by a firmware that has a privilege concerning the diagnosis of the hardware while occupying the hardware. Therefore, it is possible to perform the diagnosis for the hardware in detail. On the other hand, as for the hardware diagnosis performed by the OS after activating the OS, contents of the diagnosis are limited due to the restriction of accesses to the hardware. Moreover, when the hardware diagnosis is forcibly performed by the OS while the system is operating, the OS may not operate normally.

As for the diagnosis for the hardware, there is a following conventional technique. Specifically, a service processor performs a failure diagnosis for a spare processor that is in standby. Then, when the result of the failure diagnosis represents it is rightly operating, the OS separates an operational processor that is operating to cause it to wait for a moment, and the spare processor, for which the failure diagnosis has been completed, is incorporated to the computer system, and is operated. However, in this technique, when a system (subsystem) on which the service processor is equipped is down, the diagnosis cannot be performed for the operational processor equipped on the system (main system) that is operating. Recently, along with the increase of the number of components or the like, the occurrence ratio of the failures in the subsystem tends to increase. Therefore, such a technique has a problem.

Moreover, as for the operational verification of the apparatus, there is a following technique. Specifically, a virtual computer controller performs a test for generation, deletion, suspension and resume of a virtual computer. Moreover, the virtual computer controller holds information of a shared apparatus that the virtual computers share. Accordingly, each virtual computer can perform the operational verification while confirming the sharing state of the shared apparatus. However, such a technique cannot perform the diagnosis for the hardware allocated to each virtual computer.

Patent Document 1: Japanese Laid-open Patent Publication No. 2006-252429

Patent Document 2: Japanese Laid-open Patent Publication No. 08-305596

As described above, there is no technique for enabling to appropriately perform the hardware diagnosis while the system is operating.

### SUMMARY

An information processing apparatus relating to one aspect of this technique includes a memory and a processing apparatus that is configured to execute an operating system, and execute a processing for one or plural logical domains that provide a predetermined function as a computer and a hypervisor that manages the one or plural logical domains. Moreover, the aforementioned operating system is configured to execute a process comprising: detecting a hardware resource to be diagnosed; upon detecting the hardware resource to be diagnosed, securing a first memory area in the memory, which is used in a processing for diagnosis by the operating system; instructing a kernel of the operating system to ignore an error that will occur in the first memory area; and upon detecting the hardware resource to be diagnosed, outputting a diagnosis request that instructs to ignore the error that will occur in a second memory area used for the diagnosis and includes designation of the hardware resource to be diagnosed to the hypervisor, and Furthermore, the hypervisor is configured to execute a process comprising: upon receipt of the diagnosis request, first performing a setting to ignore the error that will occur in a second memory area used for the diagnosis; and upon the receipt of the diagnosis request, second performing the diagnosis for the hardware resource to be diagnosed.

The object and advantages of the embodiment will be realized and attained by means of the elements and combinations particularly pointed out in the claims.

It is to be understood that both the foregoing general description and the following detailed description are exemplary and explanatory and are not restrictive of the embodiment, as claimed.

### BRIEF DESCRIPTION OF DRAWINGS

FIG. 1 is a diagram to explain a problem when diagnosis for hardware resources is performed;

FIG. 2 is a diagram to explain a problem when diagnosis for the hardware resources is performed;

FIG. 3A is a diagram depicting a hardware configuration of an information processing apparatus in a first embodiment;

FIG. 3B is a diagram depicting a configuration of a main system in the first embodiment;

FIG. 4 is a diagram depicting an example of data stored in a diagnosis definition table;

FIG. 5 is a diagram depicting an example of data stored in a management table;

FIG. 6 is a diagram depicting an example of data stored in an allocation table;

FIG. 7 is a diagram depicting a main processing flow in the first embodiment;

FIG. 8 is a diagram depicting a main processing flow in the first embodiment;

FIG. 9 is a diagram depicting a processing flow of a diagnosis processing in the first embodiment;

FIG. 10 is a diagram depicting an outline of the diagnosis method of the hardware resource relating to the first embodiment;

FIG. 11 is a diagram depicting an example of data stored in the diagnosis definition table relating to the second embodiment;

FIG. 12 is a diagram depicting a main processing flow in the second embodiment;

FIG. 13 is a diagram depicting a processing flow of the diagnosis processing in the second embodiment; and

FIG. 14 is a diagram depicting an example of data stored in the management table.

### DESCRIPTION OF EMBODIMENTS

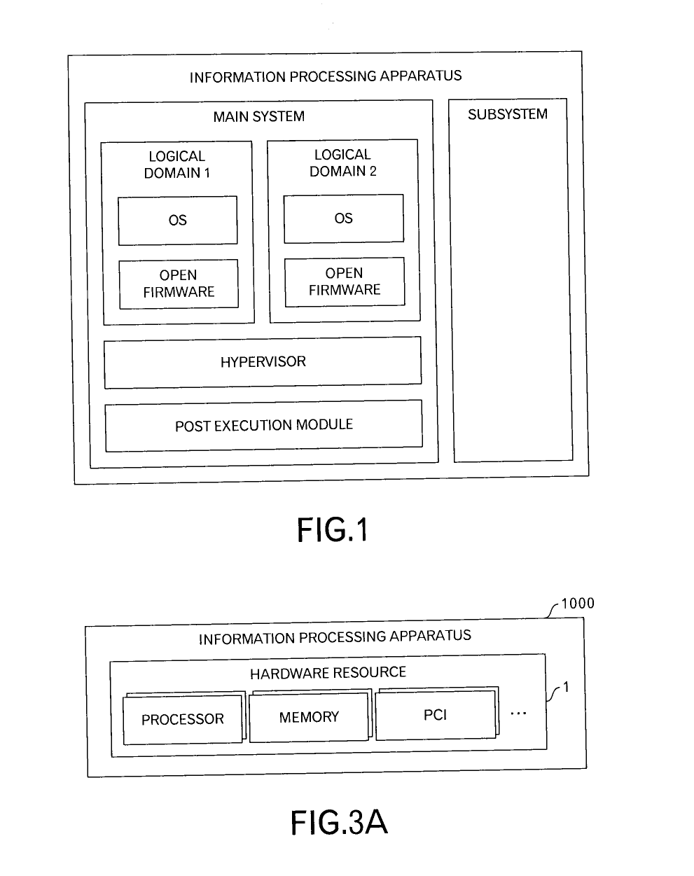

For example, a case is considered where the diagnosis for hardware resources is performed in an information processing apparatus as illustrated in FIG. 1. The information processing apparatus in FIG. 1 includes a main system and subsystem. Here, the main system is a system for performing transactions, and the main system includes a logical domain 1, logical domain 2 and programs such as a hypervisor that manages each logical domain. Each program included in the main system is executed by a processor included in the hardware resources. The subsystem is a system for operating and managing the main system. A POST execution module is a software for executing the POST. The hypervisor is a firmware for activating the logical domain. An open firmware (also called “open boot”) is a software for activating the OS.

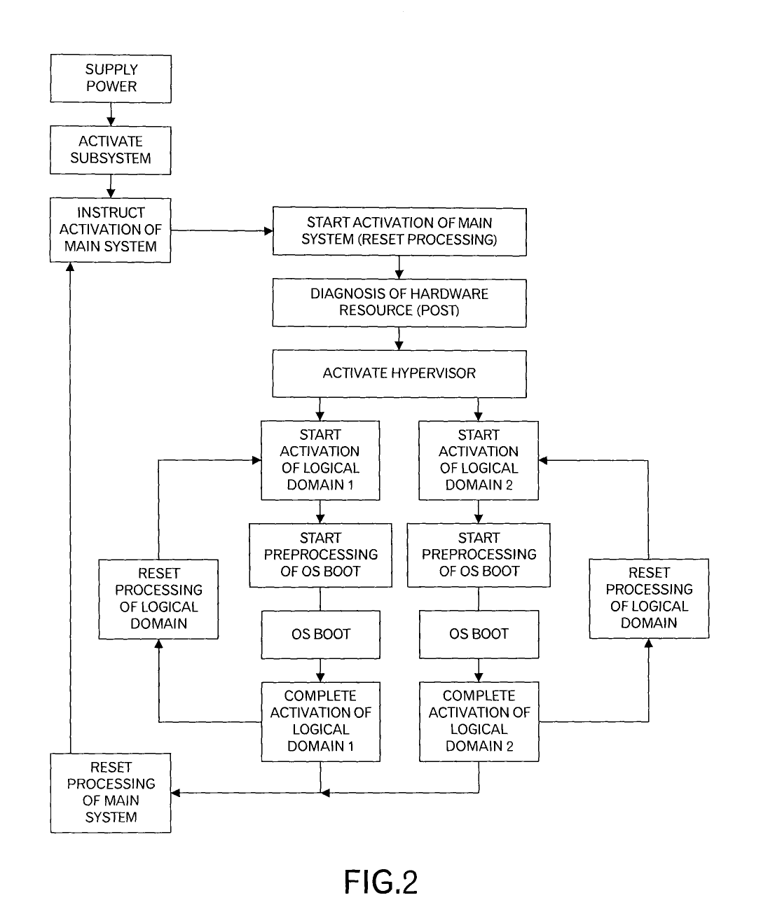

The diagnosis for the hardware resources in this information processing apparatus is performed as illustrated in FIG. 2, for example. Specifically, when the power is firstly supplied to the information processing apparatus, the subsystem is activated, and an activation instruction of the main system is outputted from the subsystem. Then, the activation of the main system is started, and the diagnosis (POST) for the hardware resources is performed by the POST execution module.

When the POST is performed, the hypervisor is activated, and the hypervisor activates the logical domains. Then, the open firmware begins a preprocessing of the OS activation, and further activates the OS. Then, the activation of the logical domains is complete, and transactions are performed in the logical domains.

Here, while the logical domains are operating, when an instruction to the effect that the logical domain is reset is received from a user, only the logical domain relating to the instruction is reactivated. However, only by resetting the logical domain, the main system itself is not resetted. Therefore, the POST is not performed. Then, in order to perform the POST, a countermeasure is considered that the main system is reactivated, however, in such a countermeasure, all of the logical domains are reactivated.

However, because a different transaction processing is performed in each logical domain, a timing when plural logical domains can be reactivated simultaneously is often limited. Therefore, it is impossible to reactivate the main system in actual, and the detection of the failure of the hardware resources may be delayed.

Then, two embodiments in which the diagnosis for the hardware is appropriately performed while the system is operating will be explained in the following.

### Embodiment 1

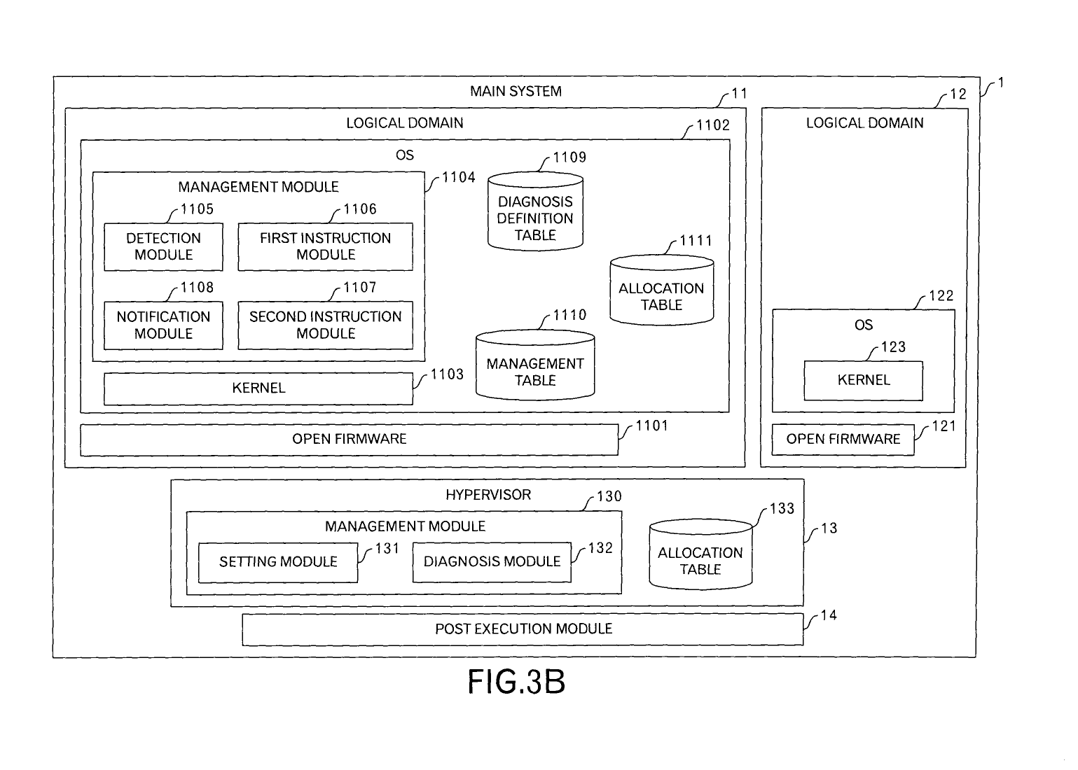

A hardware configuration of an information processing apparatus 1000 in this embodiment is illustrated in FIG. 3A. In an example of FIG. 3A, the information processing apparatus 1000 has a hardware resource 1, and executes, by the hardware resource 1, the main system for performing transactions and the subsystem for operating and managing the main system. The hardware resource 1 includes hardware resources such as a processor, memory, Peripheral Component Interconnect (PCI) bus and the like. The number of hardware resources for each type is one or more, and the number of hardware resources for which the diagnosis is performed is two or more. The subsystem does not perform any main processing in this embodiment, the detailed explanation for the subsystem will be omitted.

FIG. 3B illustrates a configuration of the main system. The main system includes a logical domain 11, logical domain 12, hypervisor 13 and POST execution module 14. The logical domains 11 and 12 are systems that are realized virtually by the hypervisor 13.

The logical domain 11 includes an open firmware 1101 and OS 1102. Moreover, the OS 1102 includes a kernel 1103, management module 1104, diagnosis definition table 1109, management table 1110 and allocation table 1111. Moreover, the management module 1104 includes a detection module 1105, first instruction module 1106, second instruction module 1107 and notification module 1108.

The open firmware 1101, OS 1102, kernel 1103 and each module are executed by a processor included in the hardware resource 1, for example, following functions that will be explained later are realized.

The open firmware 1101 performs a processing to activate the OS 1102. The kernel 1103 performs a well-known processing that is performed by the kernel of the typical OS such as providing the resource management and the inter-process communication in the information processing apparatus 1000. The detection module 1105 uses data stored in the diagnosis definition table 1109 and management table 1110 to perform a processing to detect the hardware resource for which the diagnosis is to be performed. The first instruction module 1106 performs a processing to output a mask instruction that will be explained later for the kernel 1103 and the like. The second instruction module 1107 performs a processing to output a mask instruction that will be explained later to the hypervisor 13. The notification module 1108 performs a processing to present any abnormality of the hardware resource for the user (e.g. an administrator of the information processing apparatus 1000) and the like.

The logical domain 12 includes the open firmware 121 and OS 122 that includes the kernel 123. These functions are the same as those of the open firmware 1101 and OS 1102 in the logical domain 11, therefore, the explanation is omitted.

Although FIG. 3B depicts two logical domains, the number of logical domains is not limited. Moreover, in this embodiment, it is assumed that there is no other logical domain that has the same functions as those of the logical domain 11. In other words, the diagnosis is managed in the logical domain 11 on the basis of a single principle.

The hypervisor 13 includes a management module 130 that includes a setting module 131 and diagnosis module 132 and an allocation table 133. When the hypervisor 13 and each module included in the hypervisor 13 are executed, for example, by a processor included in the hardware resource 1, following functions that will be explained later are realized.

The setting module 131 performs a setting that the hypervisor 13 ignores an error that occurs in a predetermined memory area and the like. The diagnosis module 132 performs the diagnosis for detecting the failure of the hardware resources.

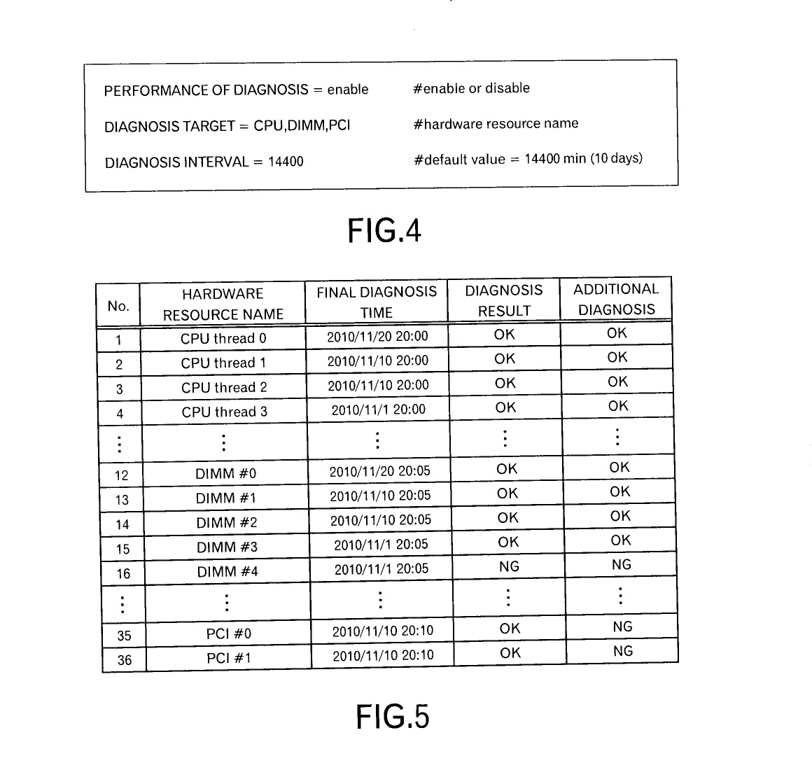

FIG. 4 illustrates an example of data stored in the diagnosis definition table 1109. In an example of FIG. 4, data to designate whether or not the diagnosis is performed, data to designate the diagnosis target and data to designate the diagnosis interval are stored. This data is data designated by the user of the information processing apparatus 1000.

FIG. 5 illustrates an example of data stored in the management table 1110. In an example of FIG. 5, a number assigned to the hardware resource, the hardware resource name, data of the final diagnosis time, diagnosis result and data representing whether or not the additional diagnosis is performed are stored. The diagnosis result is “OK” when the hardware resource is rightly operating, and the diagnosis result is “NG” when the hardware resource is failed. Moreover, the additional diagnosis becomes “OK” when the diagnosis should be performed again, and the additional diagnosis becomes “NG” when the diagnosis should not be performed again.

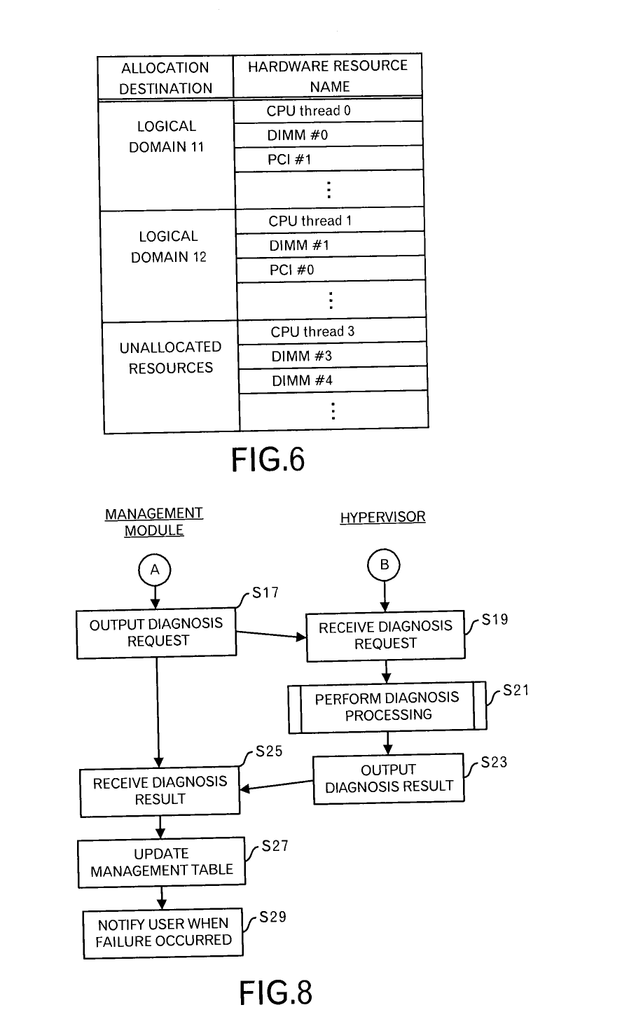

FIG. 6 illustrates an example of data stored in the allocation table 1111. In an example of FIG. 6, information of the allocation destination and hardware resource name are stored. The allocation table is a table for managing the allocation of the hardware resources that the information processing apparatus 1000 has, and the contents of the allocation table is updated when the allocation is changed. The allocation table 133 also stores the same data as the allocation table 1111.

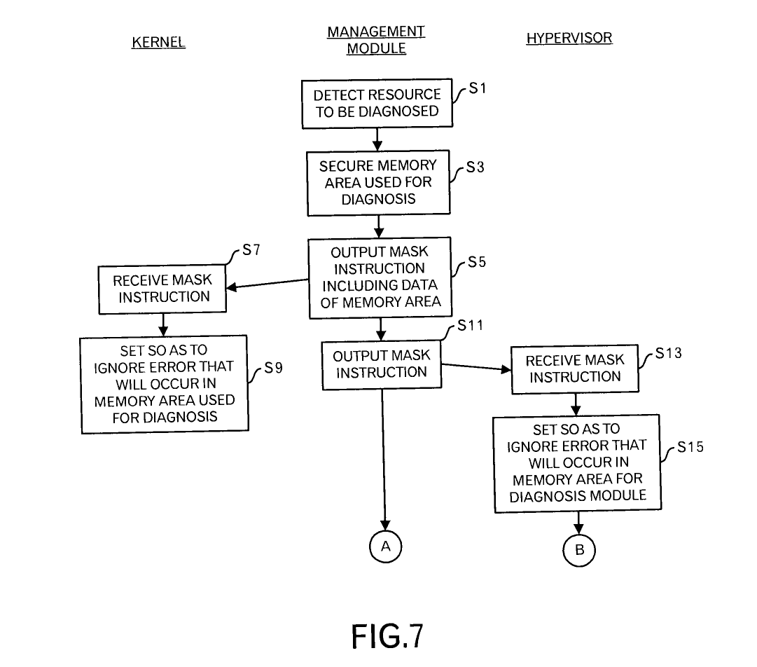

Next, the processing contents of the information processing apparatus 1000 in the first embodiment will be explained. Firstly, the detection module 1105 in the logical domain 11 detects hardware resources for which the diagnosis is to be performed (hereinafter, referred to target resources) (FIG. 7: step S1). At the step S1, by using data of the final diagnosis time, which is stored in the management table 1110, and data of the diagnosis interval, which is stored in the diagnosis definition table 1109, hardware resources, for which the diagnosis is not performed a predetermined time or more since the final diagnosis, are extracted. However, the hardware resources for which “NG” is stored in the column of the additional diagnosis are not extracted.

Then, the first instruction module 1106 secures a memory area used by the OS 1102 in the processing for the diagnosis for the target resources (step S3). Then, the first instruction module 1106 outputs a mask instruction including an address of the memory area secured at the step S3 and designation of the detected target resources (here, the hardware resource names) (step S5).

The kernel 1103 receives the mask instruction from the first instruction module 1106 (step S7). Moreover, the kernel 1103 performs a setting to ignore, by the OS 1102, an error that will occur on the notified memory area (step S9).

Moreover, the second instruction module 1107 outputs the mask instruction to the hypervisor 13 (step S11).

The hypervisor 13 receives the mask instruction from the second instruction module 1107 (step S13). Then, the setting module 131 in the hypervisor 13 performs a setting to ignore an error that will occur in the memory area for the diagnosis module 132 (i.e. the memory area in which the program to realize the diagnosis module 132 is disposed) (step S15). The processing shifts to a processing in FIG. 8 through terminals A and B.

Shifting to the explanation of the processing in FIG. 8, the second instruction module 1107 outputs a diagnosis request including the designation of the target resources detected at the step S1 to the hypervisor 13 (FIG. 8: step S17).

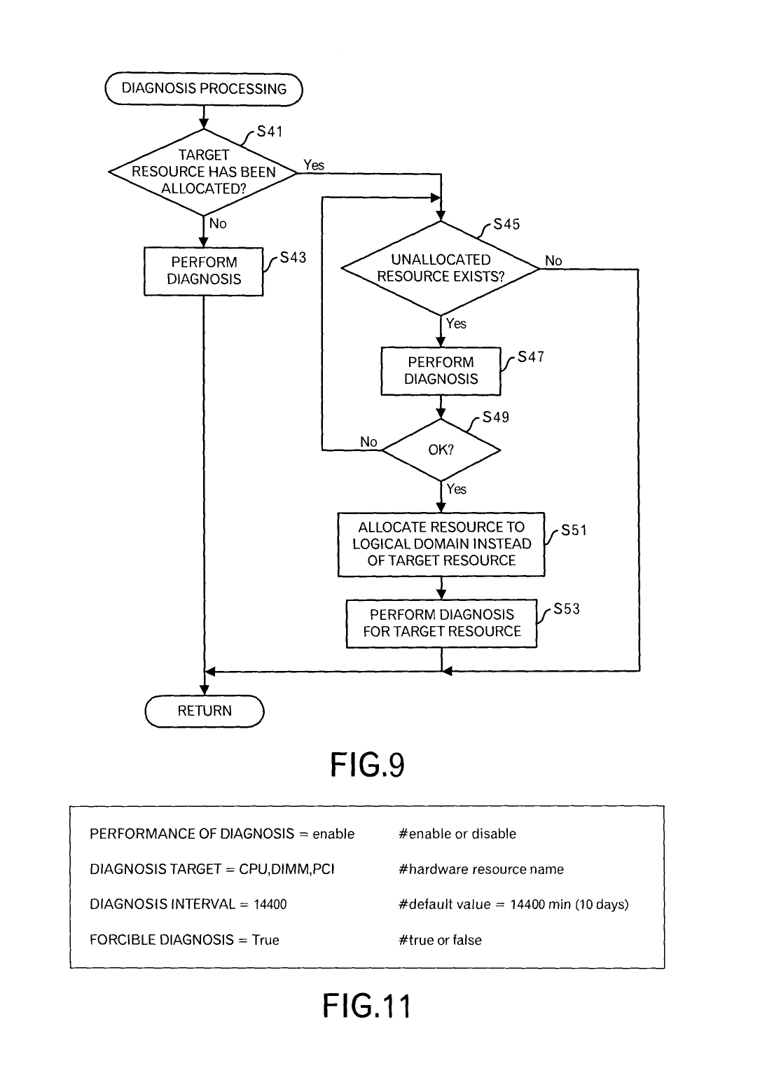

The diagnosis module 132 in the hypervisor 13 receives the diagnosis request from the second instruction module 1107 (step S19). Then, the diagnosis module 132 performs a diagnosis processing (step S21). The diagnosis processing will be explained in detail by using FIG. 9.

Firstly, the diagnosis module 132 determines whether or not the target resource has been allocated to any of logical domains by searching the allocation table 133 for the target resource name designated in the diagnosis request (FIG. 9: step S41). When the target resource has not been allocated to any of the logical domains (step S41: No route), there is no problem even when the diagnosis for the target resource is performed. Therefore, the diagnosis module 132 performs the diagnosis for the target resource (step S43). Then, the processing returns to the calling-source processing.

In this embodiment, the diagnosis module 132 uses a privilege concerning the diagnosis for the hardware resources to access a register for the target resource, for example, and performs the diagnosis for the target resource.

On the other hand, when the target resource has been allocated to any of the logical domains (step S41: Yes route), the diagnosis module 132 determines whether or not there is an unallocated hardware resource in the allocation table 133 (step S45). When it is determined that there is an unallocated hardware resource (step S45: Yes route), the diagnosis module 132 performs the diagnosis for the unallocated hardware resource (step S47).

Then, the diagnosis module 132 determines whether or not the diagnosis result represents “OK” (step S49). When the diagnosis result does not represent “OK” (step S49: No route), there is a possibility that any trouble occurs when the unallocated resource is allocated to the logical domain, the processing returns to the step S45.

On the other hand, when the diagnosis result represents “OK” (step S49: Yes route), the diagnosis module 132 allocates the unallocated resource to a logical domain instead of the target resource (step S51). Then, the diagnosis module 132 performs the diagnosis for the target resource that is released from the allocation (step S53). Then, the processing returns to the calling-source processing.

On the other hand, when there is no unallocated hardware resource (step S45: No route), the target resource cannot be released from the allocation, and it is impossible to perform the diagnosis. Therefore, the processing returns to the calling-source processing.

By doing so, even when the target resource has been allocated, it becomes possible to perform the diagnosis for the target resource without giving the influence to the logical domain that is operating.

Moreover, because the unallocated hardware resource is allocated to the logical domain after confirming that the unallocated hardware resources are rightly operating, it is possible to prevent the occurrence of the trouble in the logical domain. Furthermore, after releasing the target resource from the allocation and performing the diagnosis, the target resource is not allocated again. Therefore, the hardware resource allocated to the logical domain is exchanged. Accordingly, it is possible to suppress the lack of the balance, in other words, the specific hardware resource is continued to be allocated to the logical domain.

Returning to the explanation of FIG. 8, the diagnosis module 132 outputs the diagnosis result to the management module 1104 in the OS 1102 (step S23).

The notification module 1108 in the management module 1104 receives the diagnosis result from the diagnosis module 132 (step S25). Then, the notification module 1108 updates data stored in the management table 1110 (step S27). When the diagnosis result represents “OK”, “OK” is stored in the columns of the diagnosis result and the additional diagnosis, and when the diagnosis result represents “NG”, “NG” is stored in the columns of the diagnosis result and the additional diagnosis. Moreover, when the diagnosis is not carried out, in other words, the processing passes through No route of the step S45, “NG” is stored in the column of the additional diagnosis.

Then, when the diagnosis result does not represent “OK”, the notification module 1108 generates data to cause the user to recognize the occurrence of the failure, and causes a display unit (not depicted) to display the generated data to notify the user (step S29). Moreover, the notification module 1108 registers a name of the hardware resource in which the failure occurred and the occurrence time in an event log table (not depicted).

By carrying out the aforementioned processing, the OS 1102 and hypervisor 13 are not badly influenced by an error that occurred in the predetermined memory area during the diagnosis of the hardware resource (e.g. falling into panicky). Therefore, even when the logical domain is operating, it is possible to perform the appropriate hardware diagnosis by using the privilege of the hypervisor 13, and it is also possible to prevent the detection of the failure from being delayed. In other words, the failure of the hardware resource can be earily detected, and the stable operation of the main system can be realized.

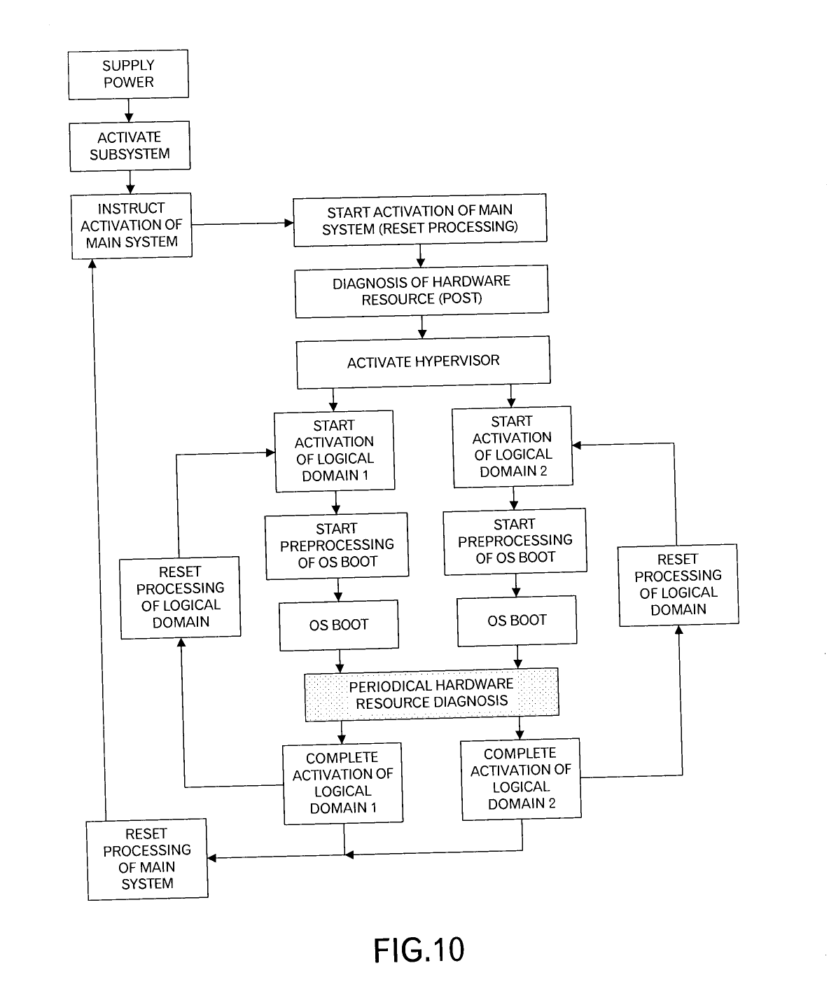

Here, FIG. 10 illustrates an outline of the diagnosis method of the hardware resources relating to the first embodiment. According to the first embodiment, it becomes possible to perform the periodical diagnosis for each hardware resource when the logical domain is operating. In other words, without resetting the main system or logical domain, it becomes possible to perform the diagnosis for the hardware resource.

### Embodiment 2

Next, the second embodiment will be explained. The second embodiment is different from the first embodiment in a point that the diagnosis is forcibly performed for the target resource even when the target resource has been allocated and there is no unallocated hardware resource.

As for the configuration of the information processing apparatus 1000 in the second embodiment, differences from the first embodiment will be explained.

FIG. 11 illustrates an example of data stored in the diagnosis definition table 1109. In an example of FIG. 11, data to designate whether or the diagnosis is performed, data to designate the diagnosis target, data to designate the diagnosis interval and data to designate whether or not the forcible diagnosis is enabled are stored.

Other portions are the same as those in the first embodiment.

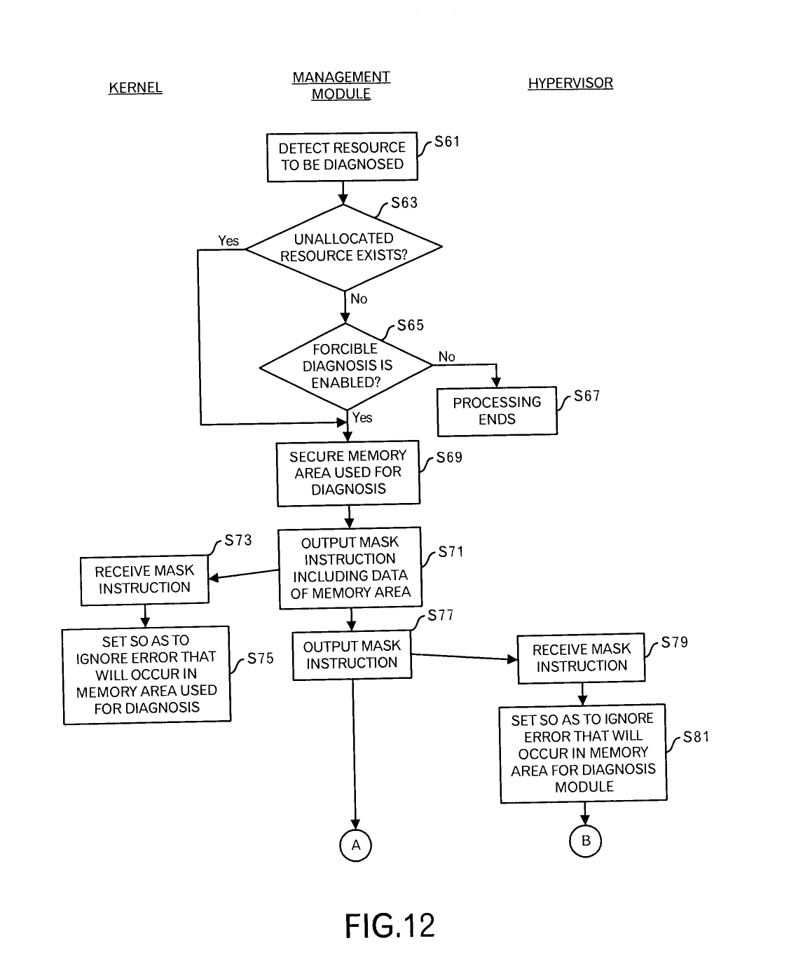

Next, the processing contents of the information processing apparatus 1000 in the second embodiment will be explained. Firstly, the detection module 1105 in the logical domain 11 detects the hardware resource for which the diagnosis should be performed (hereinafter, called “target resource”) (FIG. 12: step S61). The detection method was as explained in the explanation of the step S1.

Then, the detection module 1105 determines whether or not there is an unallocated hardware resource in the allocation table 1111 (step S63). When it is determined that there is an unallocated hardware resource (step S63: Yes route), it is possible to perform the diagnosis for the target resource without determining whether or not the forcible diagnosis can be performed, and the processing shifts to a processing of step S69.

On the other hand, when it is determined that there is no unallocated hardware resource (step S63: No route), the detection module 1105 determines whether or not the forcible diagnosis in the diagnosis definition table 1109 is enabled (step S65). When it is determined that the forcible diagnosis is not enable (step S65: No route), it is impossible to perform the diagnosis for the target resource, and the processing ends (step S67).

On the other hand, when it is determined that the forcible diagnosis is enabled (step S65: Yes route), it is possible to perform the diagnosis by considering the hardware resource that has been allocated as the unallocated hardware resource. Therefore, the first instruction module 1106 secures a memory area used by the OS 1102 in the processing for the diagnosis for the target resource (step S69). Then, the first instruction module 1106 outputs a mask instruction including the address of the memory area secured at the step S69 to the kernel 1103 (step S71).

The kernel 1103 receives the mask instruction from the first instruction module 1106 (step S73). Moreover, the kernel 1103 performs a setting to ignore, by the OS 1102, an error that may occur on the notified memory area (step S75).

In addition, the second instruction module 1107 outputs the mask instruction to the hypervisor 13 (step S77).

The hypervisor 13 receives the mask instruction from the second instruction module 1107 (step S79). Then, the setting module 131 in the hypervisor 13 performs a setting to ignore the error that may occur in the memory area for the diagnosis module 132 (i.e. the memory area in which the program to realize the diagnosis module 132 is disposed.) (step S81). Then, the processing shifts to the processing in FIG. 8 through the terminals A and B.

By carrying out such a processing, it becomes possible to cause the diagnosis module 132 in the hypervisor 13 to perform the forcible diagnosis.

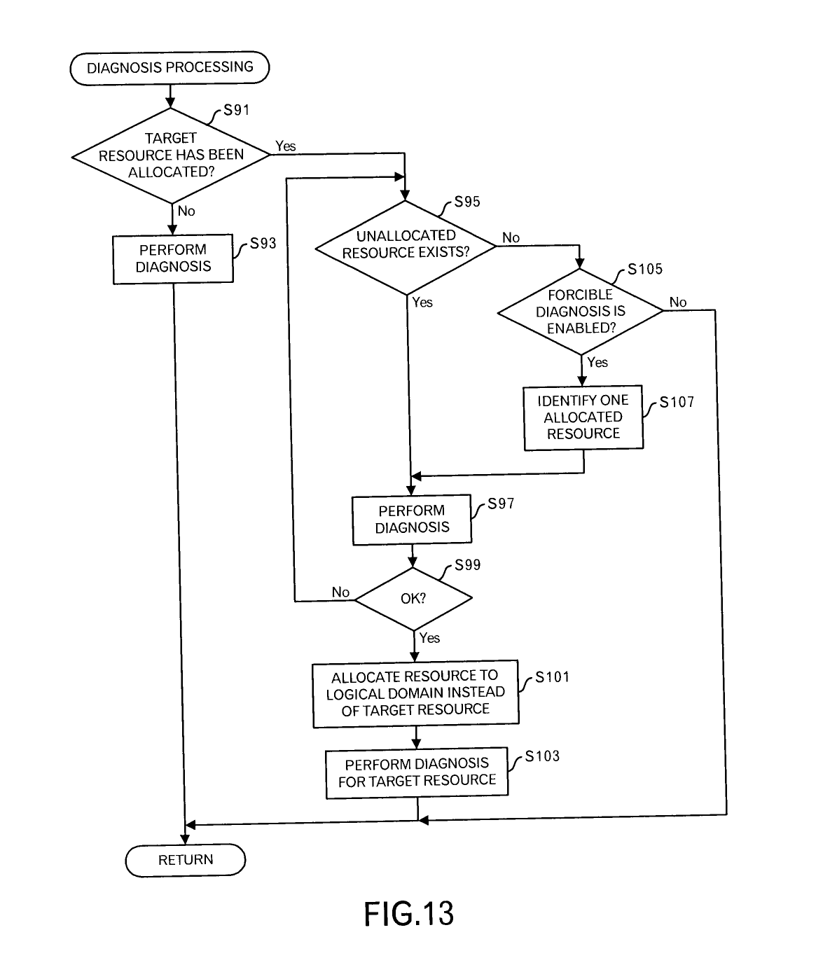

In addition, the diagnosis processing in the second embodiment is different from the diagnosis processing in the first embodiment. Then, the diagnosis processing in the second embodiment will be explained by using FIG. 13.

Firstly, the diagnosis module 132 determines whether or not the target resource has been allocated to any of the logical domains by searching the allocation table 133 for the hardware resource name of the target resource designated in the diagnosis request (FIG. 13: step S91). When the target resource has not been any of the logical domains (step S91: No route), there is no problem even when the diagnosis for the target resource is executed by the diagnosis module 132. Then, the processing returns to the calling-source processing.

Similarly to the first embodiment, by using the privilege concerning the diagnosis of the hardware resource and accessing any register in the target resource, for example, the diagnosis module 132 performs the diagnosis for the target resource.

On the other hand, when the target resource is allocated to any of the logical domains (step S91: Yes route), the diagnosis module 132 determines whether or not there is an unallocated hardware resource in the allocation table 133 (step S95). When it is determined that there is an unallocated hardware resource (step S95: Yes route), the diagnosis module 132 performs the diagnosis for the unallocated resources (step S97).

Then, the diagnosis module 132 determines whether or not the diagnosis result represents “OK” (step S99). When the diagnosis result does not represent “OK” (step S99: No route), there is a possibility that any trouble may occur in the logical domain when the unallocated resource is allocated to the logical domain. Therefore, the processing returns to the step S95.

On the other hand, when the diagnosis result represents “OK” (step S99: Yes route), the diagnosis module 132 allocates the unallocated resource to the logical domain instead of the target resource (step S101). Then, the diagnosis module 132 performs the diagnosis for the target resource that was released from the allocation (step S103). Then, the processing returns to the calling-source processing.

On the other hand, when it is determined there is no unallocated hardware resource (step S95: No route), the diagnosis module 132 determines whether or not the forcible diagnosis is enabled in the diagnosis definition table 1109 (step S105). When the forcible diagnosis is not enabled (step S105: No route), it is impossible to release the target resource from the allocation, and it is impossible to perform the diagnosis. Therefore, the processing returns to the calling-source processing.

On the other hand, when the forcible diagnosis is enabled (step S105: Yes route), the diagnosis module 132 identifies one hardware resource that has been allocated in the allocation table 133 (step S107), and performs the diagnosis for that hardware resource (step S97). The processing of the step S99 and following processing is as explained above.

By carrying out such a processing, even when the target resource has been allocated to the logical domain and there is no unallocated hardware resource, in other words, even when there are few surplus hardware resources, it is possible to certainly perform the diagnosis.

Although the embodiments of this technique were explained above, this technique is not limited to these. For example, the configuration of the aforementioned information processing apparatus 1000 does not always correspond to an actual program module configuration.

Moreover, as for the aforementioned processing flow, as long as the processing results do not change, turns of the processing may be exchanged, and furthermore, the processing may be executed in parallel.

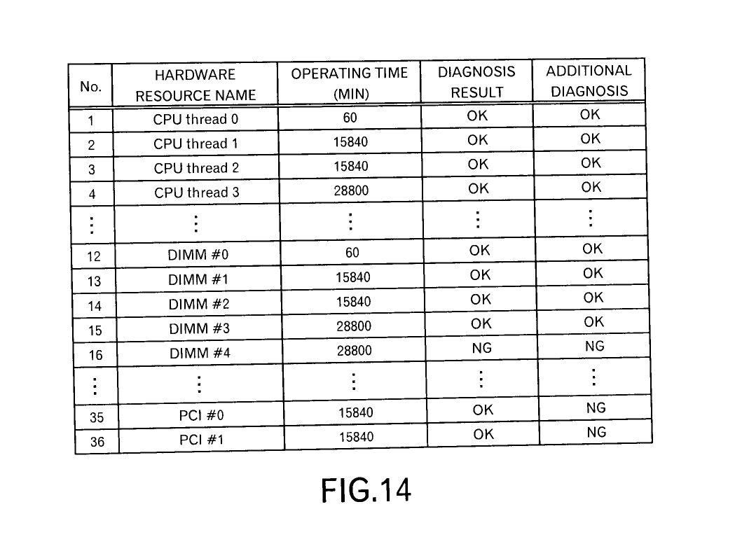

In the management table illustrated in FIG. 5, an example was depicted that the final diagnosis time is managed, however, as illustrated in FIG. 14, a period that elapsed since the final diagnosis (i.e. operating time) may be managed. In such a case, by performing the diagnosis when the operating time exceeds the diagnosis interval, it is possible to periodically perform the diagnosis for the hardware resource.

Moreover, in the second embodiment, when the detection module 1105 in the OS 1102 confirmed at the step S65 whether or not the forcible diagnosis is enabled, whether or not the forcible diagnosis is enabled may be notified to the diagnosis module 132 in the hypervisor 13. By doing so, the diagnosis module 132 does not have to determine whether or not the forcible diagnosis is enabled at the step S105.

In addition, in the aforementioned example, when the target resource has been allocated to any of the logical domains, another hardware resource is allocated instead of the target resource, and then the diagnosis for the target resource is performed. Then, after the completion of the diagnosis for the target resource, the target resource is not allocated again to the logical domain, however, when the target resource has no failure, the target resource may be allocated again to the logical domain.

Furthermore, at the step S17, the designation of the target resource is notified from the second instruction module 1107 to the hypervisor 13, however, the kernel 1103 that received the mask instruction may notify the hypervisor 13 of the designation of the target resource.

The aforementioned embodiments are outlined as follows:

An information processing apparatus relating to the embodiments includes (A) a memory and (B) a processing apparatus that is configured to execute an operating system, and execute a processing for one or plural logical domains that provide a predetermined function as a computer and a hypervisor that manages the one or plural logical domains. Moreover, the aforementioned operating system includes: (b1-1) a detect ion module to detect a hardware resource to be diagnosed; (b1-2) a first instruction module to secure, upon detecting the hardware resource to be diagnosed, a first memory area in the memory, which is used in a processing for diagnosis by the operating system, and to instruct a kernel of the operating system to ignore an error that will occur in the first memory area; and (b1-3) a second instruction module to output, upon detecting the hardware resource to be diagnosed, a diagnosis request that instructs to ignore the error that will occur in a second memory area used for the diagnosis and includes designation of the hardware resource to be diagnosed to the hypervisor. Furthermore, the aforementioned hypervisor includes: (b2-1) a setting module to perform, upon receipt of the diagnosis request, a setting to ignore the error that will occur in the second memory area used for the diagnosis; and (b2-2) a diagnosis module to perform, upon the receipt of the diagnosis request, the diagnosis for the hardware resource to be diagnosed.

With such a configuration, even while the logical domain is operating, it is possible to perform appropriate hardware diagnosis by the hypervisor without influencing the processing of the operating system and the hypervisor. The aforementioned processing apparatus is realized, for example, by a processor and programs executed by the processor.

Moreover, the aforementioned diagnosis module may (b2-21) perform, upon detecting that the hardware resource to be diagnosed is allocated to any of the one or plural logical domains, the diagnosis for the hardware resource to be diagnosed, after a first hardware resource that is not allocated to any of the one or plural logical domains among hardware resources that the information processing apparatus has is allocated instead of the hardware resource to be diagnosed. By doing so, even when the hardware resource to be diagnosed has already been allocated to the logical domain, it is possible to perform the diagnosis while continuing the operation of the logical domain. Furthermore, it is possible to prevent the lack of balance in the use of the hardware resource, such as a case where a specific hardware resource is continued to be allocated to the logical domain.

Moreover, the aforementioned diagnosis module may (b2-22) perform the diagnosis for the first hardware resource that is not allocated to any of the one or plural logical domains among the hardware resources that the information processing apparatus has; and allocate, upon detecting that a diagnosis result represents the first hardware resource is rightly operating, the first hardware resource instead of the hardware resource to be diagnosed. With this configuration, it is possible to avoid the occurrence of any trouble caused by allocating the failed hardware to the logical domain.

Moreover, upon detecting that the hardware resource to be diagnosed is allocated to any of the one or plural logical domains and there is no hardware resource that is not allocated to any of the one or plural logical domains, the aforementioned diagnosis module may (b2-23) read data for definition of diagnosis methods from a table and determine whether forcible diagnosis is designated; and allocate, upon determining that the forcible diagnosis is designated, a second hardware resource that has already been allocated to any of the one or plural logical domains instead of the hardware resource to be diagnosed. Thus, even when there are few surplus hardware resources, it becomes possible to certainly perform the diagnosis.

Moreover, the aforementioned diagnosis module may (b2-24) output a result of the diagnosis to the operating system. Then, the operating system may (b1-3) generate, upon detecting that the result of the diagnosis represents that a diagnosed hardware resource has a failure, data to notify a user of a logical domain relating to the diagnosed hardware resource of the failure. Thus, it is possible for the user to cope with the failure.

Furthermore, the aforementioned detection module may (b1-11) detect a hardware resource that is not diagnosed a predetermined time or more among the hardware resources that the information processing apparatus has. With this configuration, it becomes possible to periodically perform the diagnosis.

Moreover, the aforementioned detection module may (b1-12) detect a hardware resource that is not diagnosed a predetermined time or more and was diagnosed last time as being rightly operating among the hardware resources that the information processing apparatus has. By doing so, it is possible to resolve the waste that the diagnosis is performed for the hardware, which was diagnosed as being failed in the previous diagnosis.

Moreover, an operating system included in one logical domain among logical domains realized by the hypervisor may have the detection module, first instruction module and second instruction module. With this configuration, it becomes possible to appropriately manage the hardware diagnosis.

An information processing method relating to the embodiments includes: (C) detecting a hardware resource to be diagnosed; (D) upon detecting the hardware resource to be diagnosed, securing a first memory area, which is used in a processing for diagnosis by an operating system that is included in a logical domain that is a virtually realized system; (E) instructing a kernel of the operating system to ignore an error that will occur in the first memory area; and (F) upon detecting the hardware resource to be diagnosed, outputting a diagnosis request that instructs to ignore the error that will occur in a second memory area used for the diagnosis and includes designation of the hardware resource to be diagnosed to a hypervisor that manages the logical domain.

By doing so, even when the diagnosis for the hardware resource is performed while the logical domain is operating, the diagnosis does not badly influence the processing of the operating system and the hypervisor.

An information processing method relating to a second mode of the embodiments includes (G) upon receipt of a diagnosis request that instructs to ignore an error that will occur in a memory area used for diagnosis of a hardware resource and includes designation of the hardware resource to be diagnosed from an operating system that is included in a logical domain that is a virtually realized system, performing a setting to ignore the error that will occur in the memory area used for the diagnosis by a hypervisor that manages the logical domain; and (H) performing the diagnosis for the hardware resource to be diagnosed.

By doing so, without badly affecting the processing of the hypervisor, it is possible to appropriately perform the diagnosis by the hypervisor.

Incidentally, it is possible to create a program causing a computer to execute the aforementioned processing, and such a program is stored in a computer readable storage medium or storage device such as a flexible disk, CD-ROM, DVD-ROM, magneto-optic disk, a semiconductor memory, and hard disk. In addition, the intermediate processing result is temporarily stored in a storage device such as a main memory or the like.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present inventions have been described in detail, it should be understood that the various changes, substitutions, and alterations could be made hereto without departing from the spirit and scope of the invention.

What is claimed is:

1. An information processing apparatus, comprising:
a memory; and
a processing apparatus that is configured to execute an operating system, and execute a processing for one or plural logical domains that provide a predetermined function as a computer and a hypervisor that manages the one or plural logical domains, and
wherein the operating system is configured to execute a process comprising:
detecting a hardware resource to be diagnosed;
upon detecting the hardware resource to be diagnosed, securing a first memory area in the memory, which is used in a processing for diagnosis by the operating system;
instructing a kernel of the operating system to ignore an error that will occur in the first memory area; and
upon detecting the hardware resource to be diagnosed, outputting a diagnosis request that instructs to ignore the error that will occur in a second memory area used for the diagnosis and includes designation of the hardware resource to be diagnosed to the hypervisor, and
wherein the hypervisor is configured to execute a process comprising:
upon receipt of the diagnosis request, first performing a setting to ignore the error that will occur in the second memory ar eaused for the diagnosis; and
upon the receipt of the diagnosis request, second performing the diagnosis for the hardware resource to be diagnosed.

2. The information processing apparatus as set forth in claim 1, wherein the second performing comprises:
upon detecting that the hardware resource to be diagnosed is allocated to any of the one or plural logical domains, performing the diagnosis for the hardware resource to be diagnosed, after a first hardware resource that is not allocated to any of the one or plural logical domains among hardware resources that the information processing apparatus has is allocated instead of the hardware resource to be diagnosed.

3. The information processing apparatus as set forth in claim 2, wherein the second performing further comprises:
performing the diagnosis for the first hardware resource that is not allocated to any of the one or plural logical domains among the hardware resources that the information processing apparatus has; and
upon detecting that a diagnosis result represents the first hardware resource is rightly operating, allocating the first hardware resource instead of the hardware resource to be diagnosed.

4. The information processing apparatus as set forth in claim 1, wherein the second performing further comprises:
upon detecting that the hardware resource to be diagnosed is allocated to any of the one or plural logical domains and there is no hardware resource that is not allocated to any of the one or plural logical domains, determining whether forcible diagnosis is designated; and
upon determining that the forcible diagnosis is designated, allocating a second hardware resource that has already been allocated to any of the one or plural logical domains instead of the hardware resource to be diagnosed.

5. The information processing apparatus as set forth in claim 1, wherein the second performing further comprises:
outputting a result of the diagnosis to the operating system, and
wherein the operating system is configured to execute a process further comprising:
upon detecting that the result of the diagnosis represents that a diagnosed hardware resource has a failure, generating data to notify a user of a logical domain relating to the diagnosed hardware resource of the failure.

6. The information processing apparatus as set forth in claim 1, wherein the detecting comprises:
detecting a hardware resource that is not diagnosed a predetermined time or more among the hardware resources that the information processing apparatus has.

7. The information processing apparatus as set forth in claim 1, wherein the detecting comprises:
detecting a hardware resource that is not diagnosed a predetermined time or more and was diagnosed last time as being rightly operating among the hardware resources that the information processing apparatus has.

8. The information processing apparatus as set forth in claim 1, wherein the operating system is included in any of the one or plural logical domains that are realized by the hypervisor.

9. A computer-readable, non-transitory storage medium storing a program for causing a computer to execute a process comprising:
detecting a hardware resource to be diagnosed;
upon detecting the hardware resource to be diagnosed, securing a first memory area, which is used in a processing for diagnosis by an operating system that is included in a logical domain that is a virtually realized system;
instructing a kernel of the operating system to ignore an error that will occur in the first memory area; and
upon detecting the hardware resource to be diagnosed, outputting a diagnosis request that instructs to ignore the error that will occur in a second memory area used for the diagnosis and includes designation of the hardware resource to be diagnosed to a hypervisor that manages the logical domain.

10. A computer-readable, non-transitory storage medium storing a program for causing a computer to execute a process comprising:
upon receipt of a diagnosis request that instructs to ignore an error that will occur in a memory area used for diagnosis of a hardware resource and includes designation of the hardware resource to be diagnosed from an operating system that is included in a logical domain that is a virtually realized system, performing a setting to ignore the error that will occur in the memory area used for the diagnosis by a hypervisor that manages the logical domain; and
performing the diagnosis for the hardware resource to be diagnosed.

11. An information processing method comprising:
detecting, by using an information processing apparatus, a hardware resource to be diagnosed;
securing, by using the information processing apparatus, a first memory area, which is used in a processing for diagnosis by an operating system that is included in a logical domain that is a virtually realized system;
instructing, by using the information processing apparatus, a kernel of the operating system to ignore an error that will occur in the first memory area;
performing, by using the information processing apparatus, a setting to ignore an error that will occur in a second memory area used for the diagnosis by a hypervisor that manages the logical domain; and
performing, by using the information processing apparatus, the diagnosis for the hardware resource to be diagnosed.
